(19) United States
(12) Patent Application Publication
(10) Pub. No.: US 2008/0158099 A1
(43) Pub. Date: Jul. 3, 2008

(54) Plasma display apparatus and driving method thereof

(75) Inventors: Dongki Paik, Yongin-si (KR); Kwang Yeol Choi, Seongnam (KR); Jongrae Lim, Anyang-si (KR); Wootae Kim, Yongin-si (KR); Sung Chun Choi, Anyang-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/647,414

(22) Filed: Dec. 29, 2006

(51) Int. Cl. G09G 3/28

(52) U.S. Cl. 345/60

(57) ABSTRACT

A plasma display panel comprises a front panel having a front glass, and a rear panel opposing the front panel. The rear panel includes a rear glass positioned to face the front glass, an address electrode formed on the rear glass, a lower dielectric layer covering the address electrode, a barrier rib, positioned on the lower dielectric layer, partitioning a discharge cell. At least one of a scan electrode and a sustain electrode is formed inside the barrier rib. A gap between the scan electrode and the sustain electrode is greater than a height of the barrier rib. The address electrode intersects with the scan electrode and the sustain electrode, and has a protrusion electrode in proximity to the scan electrode.

### BACKGROUND

1. Field

This document relates to a plasma display panel.

2. Related Art

In general, a plasma display panel (PDP) applies a reset pulse for initializing a discharge cell, an address pulse for selecting a cell to be discharged, and a sustain pulse for sustaining a discharge of a discharge cell to each electrode by a predetermined number of times according to a gray level value of each subfield and allows a phosphor to emit light by a gas discharge generating through applying of the pulses. The PDP repeats resetting, addressing, and sustaining in each subfield constituting a frame, and it is required to apply an erase pulse for removing wall charges remaining in each electrode side before the each subfield starts in order to improve PDP driving characteristics.

FIG. 1 is a view illustrating a structure of a general PDP.

As shown in FIG. 1, the PDP comprises a front panel 100 and a rear panel 110 that are disposed apart a predetermined distance and coupled in parallel to each other. The front panel 100 is arranged with a plurality of sustain electrode pairs in which a scan electrode 102 and a sustain electrode 103 are formed in pairs on a front glass 101, which is a display surface for displaying an image. The rear panel 110 has a plurality of address electrodes 113 arranged to intersect the plurality of sustain electrode pairs on a rear glass 111 constituting a rear surface.

The front panel 100 comprises pairs of the scan electrode 102 and the sustain electrode 103, which have a transparent electrode (a) made of transparent indium-tin-oxide (ITO) and a bus electrode (b) made of metal, for performing a mutual discharge in one discharge cell and sustaining emission of the cell. The scan electrode 102 and the sustain electrode 103 are covered with at least one upper dielectric layer 104 that limits a discharge current and that insulates each electrode pair. A protective layer 105 deposited with magnesium oxide (MgO) is formed on the upper dielectric layer 104 to facilitate a discharge condition.

The rear panel 110 comprises stripe-type (or well-type) barrier ribs 112, which are arranged in parallel, for forming a plurality of discharge spaces i.e., discharge cells. A plurality of address electrodes 113 for generating vacuum ultraviolet rays by performing an address discharge is arranged in parallel to the barrier ribs 112. Red (R), green (G) and blue (B) phosphors 114 that emit visible rays for displaying an image at an address discharge are coated over an upper surface of the rear panel 110. A lower dielectric layer 115 for protecting the address electrode 113 is formed between the address electrode 113 and the phosphor 114.

The front panel of the plasma display panel will be described in more detail with reference to FIG. 2 below.

FIG. 2 is a diagram illustrating a electric field path along which an electric field is formed between a scan electrode and a sustain electrode provided for the plasma display front panel shown in FIG. 1.

As shown in FIG. 2, The conventional plasma display front panel comprises a front glass 200, a plurality of scan electrodes 201 and sustain electrodes 202 formed on the front glass 200, and an upper dielectric layer 203 formed to cover the plurality of scan electrodes 201 and sustain electrodes 202. A protective layer 204 is formed of oxide magnesium (MgO) on an upper and side surface of the upper dielectric layer 203 to facilitate a discharge condition.

As shown in FIG. 3, a conventional plasma display rear panel comprises a rear glass 310, a plurality of address electrodes 311 formed on the rear glass 310, and a lower dielectric layer 312 formed to cover the plurality of address electrodes 311. A plurality of barrier ribs 313 are formed on an upper surface of the lower dielectric layer 312 to partition a discharge cell. A phosphor layer 314 is coated in a light emitting space between the plurality of barrier ribs 313.

However, the plasma display front panel and rear panel shown in and described with reference to FIGS. 2 and 3 has a drawback that the plasma display panel manufactured by a large size for seeking a fine pitch is limited in increasing an intensity of an electric field formed between the scan electrode and the sustain electrode in plasma surface discharge, and is deteriorated in address performance between the scan electrode and the address electrode even in plasma opposing discharge, thereby deteriorating a light emission luminance and a discharge efficiency.

### SUMMARY

In an aspect, a plasma display panel comprises a front panel having a front glass, and a rear panel opposing the front panel, wherein the rear panel comprises a rear glass positioned to face the front glass, an address electrode formed on the rear glass, a lower dielectric layer covering the address electrode, a barrier rib, positioned on the lower dielectric layer, partitioning a discharge cell, wherein at least one of a scan electrode and a sustain electrode is formed inside the barrier rib, wherein a gap between the scan electrode and the sustain electrode is greater than a height of the barrier rib, and the address electrode intersects with the scan electrode and the sustain electrode and has a protrusion electrode in proximity to the scan electrode.

The scan electrode may be formed inside the barrier rib, and the sustain electrode may be formed inside another barrier rib opposing the barrier rib inside which the scan electrode is formed.

The scan electrode and the sustain electrode each may be formed inside the barrier rib.

The scan electrode and the sustain electrode each may be formed to correspond to each other in the barrier ribs. Upper dielectric layers may be formed on one-side surfaces of the barrier ribs.

The upper dielectric layers may be formed on the one-side surfaces of the barrier ribs at which the scan electrode and the sustain electrode face with each other.

A distance between the scan electrode and the sustain electrode may be 100 um to 400 um.

A distance between the scan electrode and the sustain electrode may be 150 um to 350 um.

A distance between the scan electrode and the sustain electrode may be a distance between a transparent electrode of the scan electrode and a transparent electrode of the sustain electrode.

The protection electrode of the address electrode may be provided in plurality.

The protrusion electrode of the address electrode may be protruded from any one side or both sides of the address electrode. The plurality of protrusion electrodes may be positioned on a side surface of the address electrode, and may be connected with the address electrode to protrude by a predetermined length.

The plurality of protrusion electrodes may be positioned on an upper surface of the address electrode, and may be protruded by a predetermined length to intersect with the address electrode.

The plurality of protrusion electrodes may be positioned on an upper surface of the lower dielectric layer covering the address electrode, and may be protruded by a predetermined length to intersect with the plurality of address electrodes. A distance between the scan electrode and the sustain electrode may be 100 um to 400 um.

A distance between the scan electrode and the sustain electrode may be 150 um to 350 um.

A distance between the scan electrode and the sustain electrode may be a distance between a transparent electrode of the scan electrode and a transparent electrode of the sustain electrode.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention.

FIG. 1 is a view illustrating a structure of a general PDP;

FIG. 2 is a diagram illustrating an electric field path along which an electric field is formed between a scan electrode and a sustain electrode provided for a plasma display front panel shown in FIG. 1;

FIG. 3 is more detailed diagram illustrating an address electrode provided for a plasma display rear panel shown in FIG. 1;

FIG. 4 is a diagram illustrating plasma display front panel and rear panel according to a first exemplary embodiment of the present invention;

FIG. 5 is a diagram illustrating an electric field path along which an electric field is formed between a scan electrode and a sustain electrode provided for the plasma display front panel shown in FIG. 4;

FIG. 6 is a more detailed diagram illustrating an address electrode and a protrusion electrode provided for the plasma display rear panel shown in FIG. 4;

FIG. 7 is a diagram illustrating plasma display front panel and rear panel according to a second exemplary embodiment of the present invention;

FIG. 8 is a diagram illustrating an electric field path along which an electric field is formed between a scan electrode and a sustain electrode provided for the plasma display front panel shown in FIG. 7;

FIG. 9 is a more detailed diagram illustrating an address electrode and a protrusion electrode provided for the plasma display rear panel shown in FIG. 7;

FIG. 10 is a diagram illustrating plasma display front panel and rear panel according to a third exemplary embodiment of the present invention;

FIG. 11 is a diagram illustrating an electric field path along which an electric field is formed between a scan electrode and a sustain electrode provided for the plasma display front panel shown in FIG. 10; and

FIG. 12 is a more detailed perspective diagram illustrating a rear panel comprising an address electrode and a protrusion electrode shown in FIG. 10.

### DETAILED DESCRIPTION

Specific embodiments of the present invention will be described in a more detailed manner with reference to the drawings.

### First Embodiment

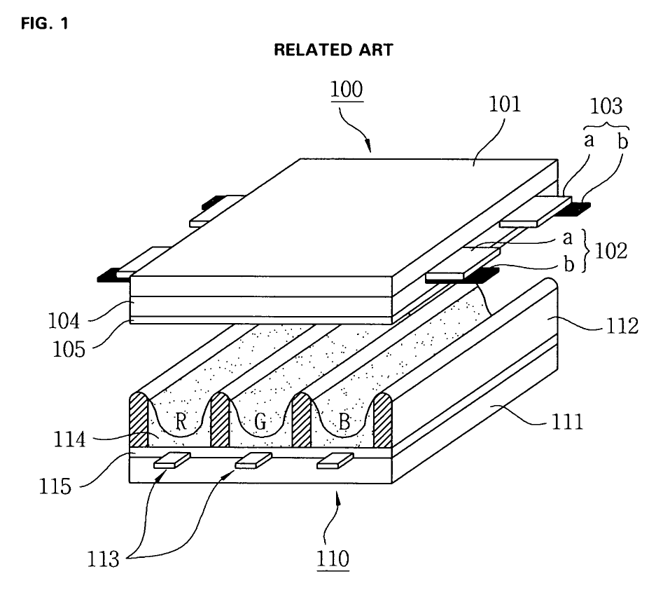

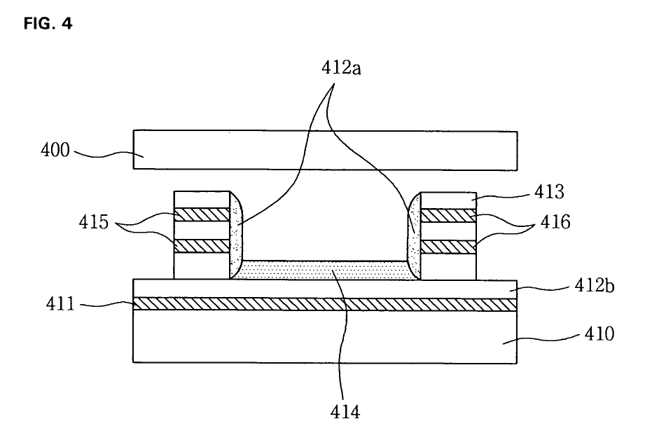

FIG. 4 is a diagram illustrating plasma display front panel and rear panel according to a first exemplary embodiment of the present invention. Unlike a plasma display front panel of FIG. 1, the plasma display front panel according to the present invention comprises only a front glass of transparent material, and the rear panel comprises a scan electrode, a sustain electrode, and an address electrode. A detailed description of the plasma display front panel and rear panel will be made with reference to FIG. 4 below.

As shown in FIG. 4, the plasma display front panel according to the present invention comprises only the front glass 400 of transparent material.

The rear panel comprises a rear glass 410; a plurality of address electrodes 411 comprising a plurality of protrusion electrodes (not shown) formed on an upper surface of the rear glass 410; and a lower dielectric layer 412b covering the plurality of address electrodes 411.

A plurality of barrier ribs 413 are formed on an upper surface of the lower dielectric layer 412b to partition a discharge cell. A phosphor layer 414 is formed in a light emitting space provided between the plurality of barrier ribs 413. One or more scan electrodes 415 and sustain electrodes 416 are formed inside the plurality of barrier ribs 413 according to the present invention. Desirably, the scan electrode 415 is formed inside one of the plurality of barrier ribs 413, and the sustain electrode 416 is formed inside another barrier rib 413 positioned to face the one barrier rib 413 and formed to partition one discharge cell. More desirably, the scan electrode 415 and the sustain electrode 416 each are positioned in the centers of the barrier ribs 413, and are formed to correspond to each other in the barrier ribs 413.

Upper dielectric layers 412a are formed on one-side surfaces of the barrier ribs 413 comprising the scan electrode 415 and the sustain electrode 416. Desirably, the upper dielectric layers 412a are formed on one-side surfaces of the barrier ribs 413 on which the scan electrode 415 and the sustain electrode 416 face with each other.

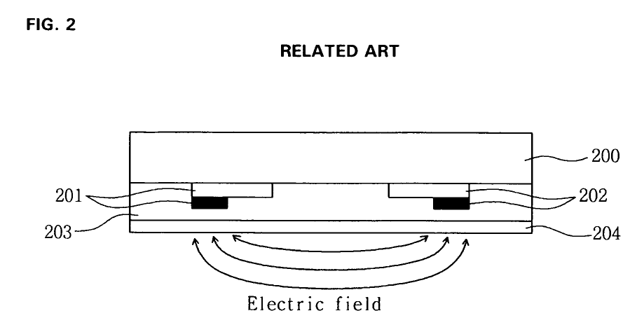

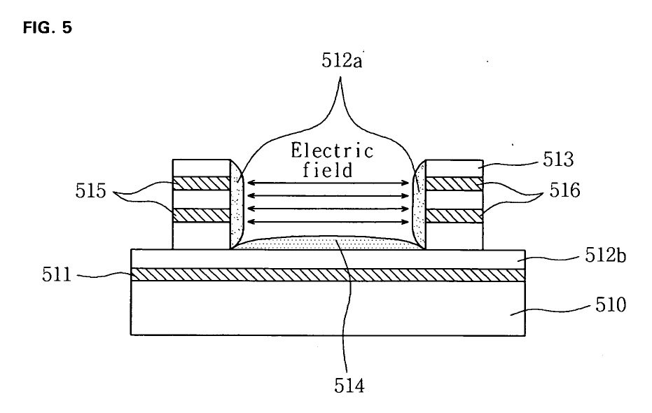

As shown in FIG. 5, a plasma display panel manufactured by a large size for seeking a fine pitch according to the present invention provides a greater intensity of an electric field formed between a scan electrode 515 and a sustain electrode 516 in plasma surface discharge than an intensity of an electric field formed between a scan electrode 201 and a sustain electrode 202 shown in FIG. 2.

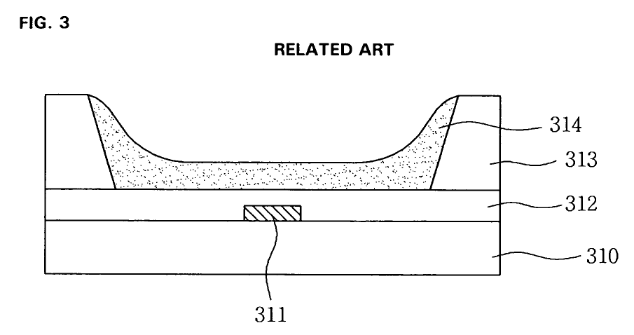

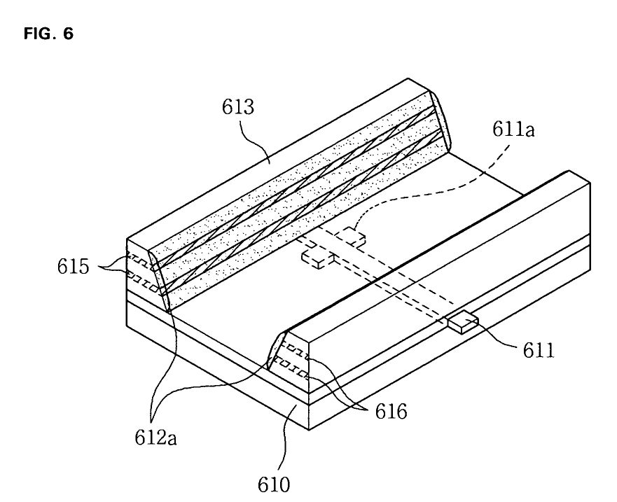

As shown in FIG. 6, a plurality of protrusion electrodes 611a are positioned on side surfaces of a plurality of address electrodes 611 in proximity to a scan electrode 615 in a plasma display rear panel according to the present invention. The plurality of protrusion electrodes 611a are protruded by a predetermined length to intersect with the address electrode 611. Thus, an address performance between the scan electrode 615 and the address electrode 611 in plasma opposing discharge is more improved than in the plasma display panel shown in and described with reference to FIG. 3, thereby more increasing a light emitting luminance and a discharge efficiency. The protrusion electrode 611a can protrude from any one side or both sides of the address electrode 611. Alternatively, the protrusion electrode 611a can be provided in plurality in the address electrode formed in one discharge cell.

Because the plasma display panel is of a long gap structure in which a gap between the scan electrode 615 and the sustain electrode 616 is greater than a height of the barrier rib 613, its discharge efficiency can be more improved. The gap between the scan electrode 615 and the sustain electrode 616 can be within a range of about 100 μm to 400 μm. Also, the gap between the scan electrode 615 and the sustain electrode 616 can be controlled within a range of about 150 μm to 350 μm, thereby optimizing the discharge efficiency. Here, the gap between the scan electrode 615 and the sustain electrode 616 can be defined as a gap between a transparent electrode of the scan electrode 615 and a transparent electrode of the sustain electrode 616.

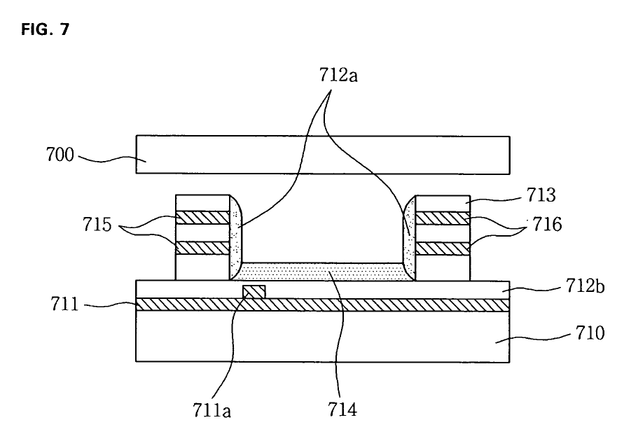

In a plasma display panel according to another exemplary embodiment of the present invention, an address electrode 611 can be improved in structure, thereby more improving a light emitting luminance and a discharge efficiency. The plasma display panel according to another exemplary embodiment of the present invention will be described with reference to FIG. 7.

A distance between the scan electrode and the sustain electrode may be 100 um to 400 um. Further, discharge efficiency can be increased in a long gap structure in which a distance between the scan electrode and the sustain electrode is adjusted to 150 um to 350 um. Here, a distance between the scan electrode and the sustain electrode may be defined as a distance between a transparent electrode of the scan electrode and a transparent electrode of the sustain electrode.

### Second Embodiment

FIG. 7 is a diagram illustrating plasma display front panel and rear panel according to a second exemplary embodiment of the present invention. The plasma display panel according to the present invention is formed in the same manner as the plasma display panel shown in and described with reference to FIG. 4. However, a plurality of protrusion electrodes 711a are formed on upper surfaces of a plurality of address electrodes 711 in the rear panel of the plasma display panel according to the present invention. The plasma display panel according to the present invention will be described in more detail with reference to FIG. 7 below.

As shown in FIG. 7, the plasma display front panel according to the present invention comprises only a front glass 700 of transparent material.

The rear panel comprises a rear glass 710; a plurality of address electrodes 711 comprising a plurality of protrusion electrodes 711a formed on an upper surface of the rear glass 710; and a lower dielectric layer 712b covering the plurality of address electrodes 711. In the present invention, the plurality of address electrodes 711 comprise the plurality of protrusion electrodes 711a in proximity to the scan electrode 715. The plurality of protrusion electrodes 711a are positioned on upper surfaces of the plurality of address electrodes 711. The plurality of protrusion electrodes 711a intersect with the plurality of address electrodes 711 to protrude by a predetermined length. The protrusion electrode 711a can protrude from any one side or both sides of the address electrode 711. Alternatively, the protrusion electrode 711a can be provided in plurality in the address electrode formed in one discharge cell.

A plurality of barrier ribs 713, a phosphor layer 714, the scan electrode 715, and a sustain electrode 716 are formed on an upper surface of the lower dielectric layer 712b in the same manner as in the plasma display panel shown in and described with reference to FIG. 4. Thus, their descriptions will be omitted below.

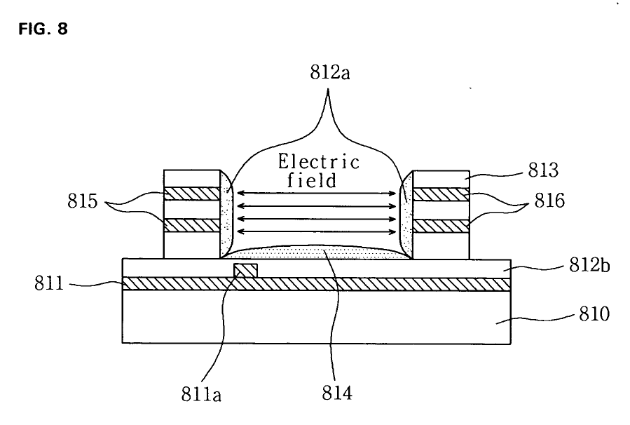

As shown in FIG. 8, a plasma display panel manufactured by a large size for seeking a fine pitch according to the present invention provides a greater intensity of an electric field formed between a scan electrode 815 and a sustain electrode 816 in plasma surface discharge than an intensity of an electric field formed between a scan electrode 201 and a sustain electrode 202 shown in FIG. 2.

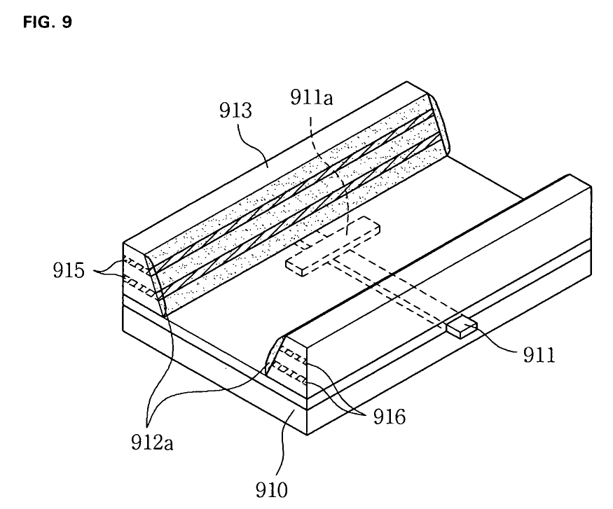

As shown in FIG. 9, a plurality of protrusion electrodes 911a are positioned on side surfaces of a plurality of address electrodes 911 in proximity to a scan electrode 915 in a plasma display rear panel according to the present invention. The plurality of protrusion electrodes 911a are protruded by a predetermined length. Thus, an address performance between the scan electrode 915 and the address electrode 911 in plasma opposing discharge is more improved than in the plasma display panel shown in and described with reference to FIG. 6, thereby more increasing a light emitting luminance and a discharge efficiency.

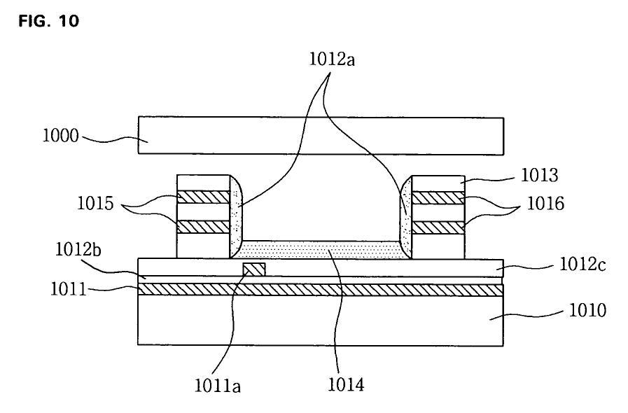

In a plasma display panel according to another exemplary embodiment of the present invention, an address electrode can be improved in structure, thereby more improving a light emitting luminance and a discharge efficiency. The plasma display panel according to another exemplary embodiment of the present invention will be described with reference to FIG. 10.

### Third Embodiment

FIG. 10 is a diagram illustrating plasma display front panel and rear panel according to a third exemplary embodiment of the present invention. The plasma display panel according to the present invention is formed in the same manner as the plasma display panel shown in and described with reference to FIGS. 4 and 7. However, a plurality of protrusion electrodes 1011a are positioned on an upper surface of a lower dielectric layer 1012b formed to cover a plurality of address electrodes 1011, and are protruded by a predetermined length to intersect with the plurality of address electrodes 1011 in the rear panel of the plasma display panel according to the present invention. The plasma display panel according to the present invention will be described in more detail with reference to FIG. 10 below.

As shown in FIG. 10, the plasma display front panel according to the present invention comprises only a front glass 1000 of transparent material.

The rear panel comprises a rear glass 1010; a plurality of address electrodes 1011 formed on an upper surface of the rear glass 1010; and a first lower dielectric layer 1012b covering the plurality of address electrodes 1011. In the present invention, the plurality of protrusion electrodes 1011a are formed on an upper surface of the first lower dielectric layer 1012b in proximity to the scan electrode 1015. A second lower dielectric layer 1012c is formed to cover the plurality of protrusion electrodes 1011a.

Desirably, the plurality of protrusion electrodes 1011a are positioned on an upper surface of the first lower dielectric layer 1012b to cover the plurality of address electrodes 1011, and are protruded by a predetermined length to intersect with the plurality of address electrodes 1011.

A plurality of barrier ribs 1013, a phosphor layer 1014, the scan electrode 1015, and a sustain electrode 1016 are formed on an upper surface of the second lower dielectric layer 1012c in the same manner as in the plasma display panels shown in and described with reference to FIGS. 4 and 7. Thus, their descriptions will be omitted below.

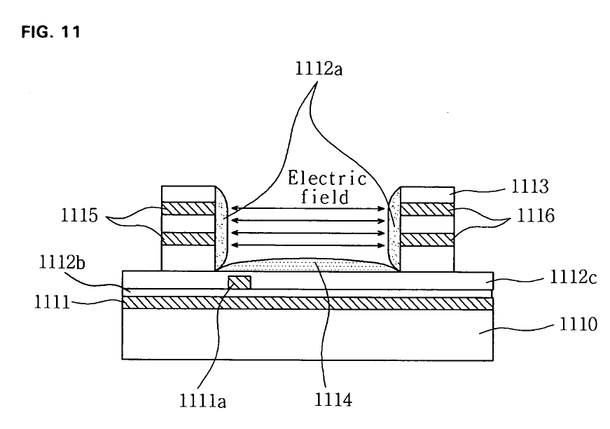

As shown in FIG. 11, a plasma display panel manufactured by a large size for seeking a fine pitch according to the present invention provides a greater intensity of an electric field formed between a scan electrode 1115 and a sustain electrode 1116 in plasma surface discharge than an intensity of an electric field formed between a scan electrode 201 and a sustain electrode 202 shown in FIG. 2.

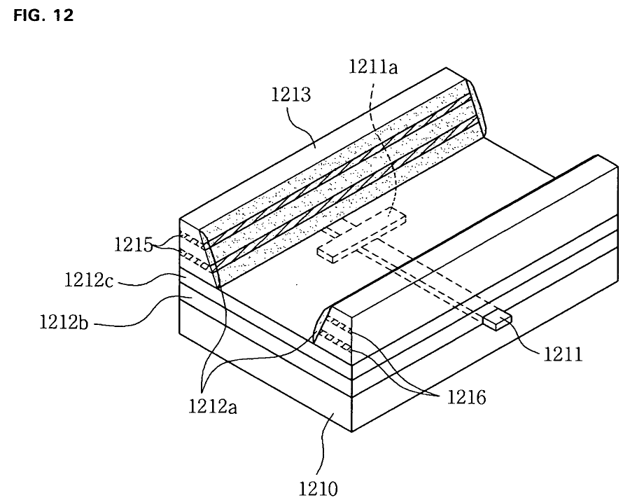

As shown in FIG. 12, a plurality of protrusion electrodes 1211a are positioned on an upper surface of a first lower dielectric layer 1212b, which is formed to cover a plurality of address electrodes 1211, in proximity to a scan electrode 1215 in a plasma display rear panel according to the present invention. The plurality of protrusion electrodes 1211a are protruded by a predetermined length to intersect with the plurality of address electrodes 1211 so that they couple with the plurality of address electrodes 1211 in plasma driving. Thus, an address performance between the scan electrode 1215 and the address electrode 1211 in plasma opposing discharge is more improved than in the plasma display panel shown in and described with reference to FIG. 9, thereby more improving a light emitting luminance and a discharge efficiency.

As described above, the present invention has an effect that the front panel and the rear panel can be improved in structure, thereby improving the light emission luminance and the discharge efficiency in plasma discharge.

The invention being thus described, it will be obvious that the same may be varied in many ways. Such variations are not to be regarded as a departure from the spirit and scope of the invention, and all such modifications as would be obvious to one skilled in the art are intended to be comprised within the scope of the following claims.

1. A plasma display panel comprising:
a front panel having a front glass; and
a rear panel opposing the front panel, the rear panel comprising:
a rear glass positioned to face the front glass;
an address electrode formed on the rear glass;
a lower dielectric layer covering the address electrode;
a barrier rib, positioned on the lower dielectric layer, partitioning a discharge cell; and
at least one of a scan electrode and a sustain electrode is formed inside the barrier rib,
wherein a distance between the scan electrode and the sustain electrode is longer than a height of the barrier rib, and the address electrode intersects with the scan electrode and the sustain electrode and has a protrusion electrode in proximity to the scan electrode.

2. The plasma display panel of claim 1, wherein the scan electrode is formed inside the barrier rib, and
the sustain electrode is formed inside another barrier rib opposing the barrier rib inside which the scan electrode is formed.

3. The plasma display panel of claim 2, wherein a scan electrode and the sustain electrode each are formed inside the barrier rib.

4. The plasma display panel of claim 3, wherein the scan electrode and the sustain electrode each are formed to correspond to each other in the barrier ribs.

5. The plasma display panel of claim 1, wherein a distance between the scan electrode and the sustain electrode is within a range of 100 um to 400 um.

6. The plasma display panel of claim 5, wherein a distance between the scan electrode and the sustain electrode is within a range of 150 um to 350 um.

7. The plasma display panel of claim 4, wherein upper dielectric layers are formed on one-side surfaces of the barrier ribs.

8. The plasma display panel of claim 7, wherein the upper dielectric layers are formed on the one-side surfaces of the barrier ribs at which the scan electrode and the sustain electrode face with each other.

9. The plasma display panel of claim 1, wherein a gap between the scan electrode and the sustain electrode is a gap between a transparent electrode of the scan electrode and a transparent electrode of the sustain electrode.

10. The plasma display panel of claim 1, wherein the protrusion electrode of the address electrode is provided in plurality.

11. The plasma display panel of claim 1, wherein the protrusion electrode of the address electrode is protruded from any one side or both sides of the address electrode.

12. The plasma display panel of claim 10, wherein the plurality of protrusion electrodes are positioned on a side surface of the address electrode, and are connected with the address electrode to protrude by a predetermined length.

13. The plasma display panel of claim 10, wherein the plurality of protrusion electrodes are positioned on an upper surface of the address electrode, and are protruded by a predetermined length to intersect with the address electrode.

14. The plasma display panel of claim 10, wherein the plurality of protrusion electrodes are positioned on an upper surface of the lower dielectric layer covering the address electrode, and are protruded by a predetermined length to intersect with the plurality of address electrodes.

15. (canceled)

16. (canceled)
